(19) United States
(12) Patent Application Publication
(10) Pub. No.: US 2015/0186907 A1
(43) Pub. Date: Jul. 2, 2015

(54) DATA MINING

(71) Applicant: EMC CORPORATION, Hopkinton, MA (US)

(72) Inventors: Li Liu, Shanghai (CN); Tianqing Wang, Shanghai (CN)

(21) Appl. No.: 14/573,235

(22) Filed: Dec. 17, 2014

(30) Foreign Application Priority Data
Dec. 27, 2013 (CN) 201310756036.8

(51) Int. Cl. G06Q 30/02; G06Q 10/08; G06F 17/30

(52) U.S. Cl. CPC G06Q 30/0202; G06F 17/30539; G06Q 10/087

(57) ABSTRACT

Embodiments of the present disclosure relate to a method and apparatus for data mining by obtaining product-related data from at least one data source; preprocessing the data to determine at least one attribute of the data; analyzing the preprocessed data with respect to product-related characteristics and at least partially based on the at least one attribute; and generating an event according to the analysis and based on a predefined rule associated with the product-related characteristics, the event predicting possible customer demands.

### RELATED APPLICATION

This Application claims priority from Provisional Application Serial No. CN201310756036.8 filed on Dec. 27, 2013 entitled “METHOD AND APPARATUS FOR DATA MINING,” the content and teachings of which are hereby incorporated by reference in their entirety.

### BACKGROUND

Embodiments of the present disclosure generally relates to data processing, and more specifically, to a method and apparatus for data mining.

With the recent advancements in science and technology, especially the development of network technology, data generated on a regular basis has been increasing at an alarming rate. People are increasingly aware of the importance of data to enterprises and thus carry out research into data analysis, data mining, data security and other aspects related to processing of data.

Data currently exists in various different forms. For example, after a customer purchases products from a vendor, a lot of useful data will be generated during the lifecycle of each product. At the same time, the vendor also generates some amount of useful data and information during updating or supporting the lifecycle of each product. Note that the term “product” here not only refers to a concrete, physical product such as a device, an apparatus, a system and so on, but also may refer to a virtual product such as a computer program product or application, and may further refer to a service being provided, such as a computing service, a training course, etc.

If on the one hand a customer buys a storage product, there will be at least the following data:

1) Sales or contract data. The data, for example, may involve model, serial number and configuration of the purchased product, and may further include the purchased support service information, like service level and effective time.
2) Product performance and usage data. Here the data may contain information related to the product's performance and usage that are generated while the customer uses the product. Taking a storage product as an example, the data may contain capacity usage, throughput information like Input/Output Operations Per Second (IOPS) or response time for processing a request, etc.
3) Support case data. For example, the data may involve symptom of each support case, support process, category of a support case and corresponding solution.
4) Education service data. For example, the data may include information on training courses subscribed or attended, related product and so on.
5) Also there may be other data, which depends on a concrete product.

On the other hand, for example, from the storage vendor's perspective there will be at least the following data:

1) Products offering data. For example, the data may include category, model and capabilities or functionalities of each product being offered.
2) Education offering data. For example, the data may include a name of the education training course provided, related product and category. Here category may refer to skill category or case category.
3) Solution offering data. For example, the data may contain category of the solution, related products and usage.
4) Also there may be other data, which depends on a concrete product.

Data is usually scattered in different systems and different forms, for example, in customer information technology (IT) systems and vendor IT systems. Also these data are usually isolated and not well consolidated, analyzed and leveraged. .

### SUMMARY

Prior art lacks a solution that is capable of presenting data in a meaningful way to a user, and there is a need for an efficient solution to mine for better data values.

To ameliorate some of the problems disclosed in the background section, this disclosure proposes a method and apparatus for mining data values.

According to one aspect of the present disclosure, there is provided a method for data mining that includes obtaining product-related data from at least one data source;

preprocessing the data to determine at least one attribute of the data; analyzing the preprocessed data with respect to product-related characteristics and being at least partially based on the at least one attribute; and generating an event in accordance with the analysis and being based on a predefined rule associated with the product-related characteristics, the event being configured to predict possible customer demands.

According to another aspect of the present disclosure, there is provided an apparatus for data mining that includes a data module configured to obtain product-related data from at least one data source; a data module configured to preprocess the data to determine at least one attribute of the data; a data module configured to analyze the preprocessed data with respect to product-related characteristics and being at least partially based on the at least one attribute, and further configured to generate an event in accordance with the analysis and being based on a predefined rule associated with the product-related characteristics, the event being configured to predict possible customer demands.

It will be understood from the following description that according to the embodiments of the present disclosure, by collecting and analyzing data from at least one data source and generating a corresponding event according to the analysis, possible customer demands can be predicted, thereby mining data values. Other advantages of the embodiments of the present disclosure will become apparent from the following description.

### BRIEF DESCRIPTION OF THE SEVERAL VIEWS OF THE DRAWINGS

Through the detailed description with reference to the accompanying drawings, the above and other objects, features and advantages of the present disclosure will become more apparent. In the accompanying drawings, several embodiments are illustrated for illustration only, rather than limiting, wherein:

FIG. 1 illustrates a block diagram of an exemplary system according to one exemplary embodiment of the present disclosure;

FIG. 2 illustrates a flowchart of a method for data mining according to one exemplary embodiment of the present disclosure;

FIG. 3 illustrates a diagram of one use case according to one exemplary embodiment of the present disclosure;

FIG. 4 illustrates a diagram of another use case according to one exemplary embodiment of the present disclosure;

FIG. 5 illustrates a diagram of a further use case according to one exemplary embodiment of the present disclosure;

FIG. 6 illustrates a diagram of a still further use case according to one exemplary embodiment of the present disclosure; and

FIG. 7 illustrates a block diagram of a computer system which is applicable to implement the embodiments of the present disclosure.

Throughout the figures, the same or corresponding numerals represent like or corresponding portions.

### DETAILED DESCRIPTION

Principles of the present disclosure will be described below with reference to the accompanying drawings, in which several exemplary embodiments have been illustrated. These embodiments are presented only to enable those skilled in the art to better understand and further implement the present disclosure, rather than limiting the scope of the present disclosure in any way.

As described previously, large amounts of data will be generated in a living and/or production environment. After carefully inspecting data, inventors have found some common, but essential attributes:

1) Time. Each kind of data is time related, i.e., has related time. For example, contact data have signed date, product shipped date and service effective/invalid date. Performance and usage data are usually time based. Support case data usually have a case occurring time and a case closed time. Training course usually have a begin date and an end date. Products have release date, update date and end of service date. Education course offering have availability date. Solution offering data have a release or availability date.
2) Product. Each data will relate to one or more specific products, i.e., has a related product. The data may further contain model, serial number and configuration information of the product.
3) Customer. Each data will have a related customer. For example, some data belong to a certain customer and some data indicate a suitable customer.
Based on the related time, the related product and the related customer, data from various data sources can be connected or related with each other to be analyzed and presented visually to customers, thereby mining the value of data.

A main indication of this disclosure is: collecting various product-related data (e.g., sales data, product and performance data, service offering data, etc.) scattered amongst different data sources (e.g., customer data source or vendor data source), and preprocessing the data so as to consolidate the data based on at least one common attribute (e.g., time, product and customer). With respect to product-related characteristics, the preprocessed data is analyzed using different analysis methods, and events are generated in accordance with the analysis and being based on a predefined rule associated with the product-related characteristics. Events can predict possible customer needs. Further, a corresponding solution can be provided in response to an event being generated. Still further, at least one of the preprocessed data, the generated event and the provided solution can be presented visually in a timeline style so as to enable a more visual and intuitive understanding.

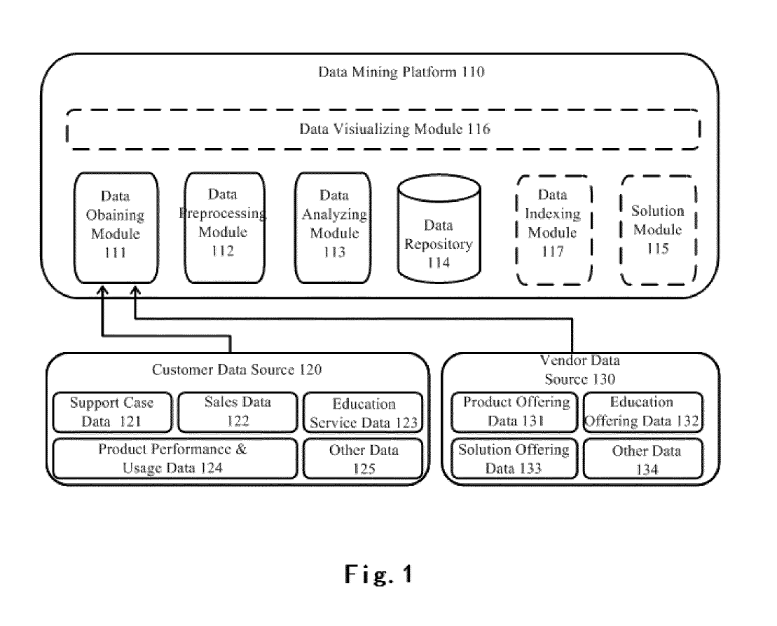

Reference is now made to FIG. 1, which illustrates a block diagram of exemplary high level system architecture according to one exemplary embodiment of the present disclosure.

The system may include a data mining platform 110 according to the embodiment of the present disclosure and at least one product-related data source. As an example, FIG. 1 shows a customer data source 120 and a vendor data source 130. Those skilled in the art may understand that there may exist more or less data sources so as to provide data be used by data mining platform 110.

Customer data source 120 may include various data, such as support case data 121, sales data 122, education service data 123, product performance and usage data 124 and other data 125.

Vendor data source 130 may also include various data, such as products offering data 131, education offering data 132, solution offering data 133 and other data 134.

Data in these data sources may be generated based on occurrence of various events. For example, in the customer data source, when the customer buys a product, corresponding sales data and education service data may be generated. While the customer uses the product, product performance and usage data, support case data and other data may be generated.

Data mining platform 110 may include a data obtaining module 111, a data preprocessing module 112, a data analyzing module 113 and a data repository 114. Optionally, data mining platform 110 may further comprise a solution module 115, a data visualizing module 116 and a data indexing module 117. In one embodiments the data obtaining module (which will also be referred to as a data module) can include all the other modules, i.e., data preprocessing module 112, data analyzing module 113, data mining platform 110 solution module 115, data visualizing module 116 and data indexing module 117 into a single component of the data module and the data module itself may be configured to perform the task of each of these modules in an ordered manner. For sake of simplicity each module will be discussed separately below, but it should be obvious to one skilled in the art that the data module can replace all the individual modules but perform the tasks associated with each of the individual modules. The data module may be a software component and/or a hardware component and/or a firmware and/or a combination of these components.

Data obtaining module 111 is configured to obtain data from at least one data source such as customer data source 120 and vendor data source 130 via a connection, preferably any type of data connection. In some embodiments, data obtaining module 111 may provide a uniform application program interface (API) to permit access to the various data sources. In other embodiments, data obtaining module 111 may provide different data interfaces for different data sources, to access data in different data sources.

The data connection may transfer various data continuously or intermittently based on a predefined arrangement (e.g., periodically or in real time in response to generation of data) or based on a request (e.g., when the data mining platform demands).

Data preprocessing module 112 is configured to preprocess the data obtained by data obtaining module 111, so as to determine at least one attribute associated with the data. As mentioned above, data may exist in all aspects of life and will have various forms, whereas the data under consideration in this disclosure have some common but essential attributes, such as related time, related product and related customer. However, in some implementations the obtained data might not explicitly contain these attributes.

Therefore, data preprocessing module 112 may be configured to preprocess the data by cleaning the data to determine at least one attribute associated with the data, such as related time, related product and related customer; and converting the at least one attribute of the data into a uniform predefined format.

Specifically, with respect to different attributes, the data cleaning may involve following operations. For example, with respect to the time attribute, related time may be extracted for the data based on some predefined rules for each kind of data. For example, time when data is obtained may be used as the related time of the data. With respect to product attribute and customer attribute, they may be determined based on some global data importing configurations. For example, it may be determined based on an Internet protocol (IP) address that the data from a specific IP address belong to customer A and product B.

After determining these attributes associated with the data, data preprocessing module 112 may be configured to convert these attributes into a uniform predefined format so as to facilitate subsequent processing.

Optional data indexing module 117 may be configured to index the data by using one of more of the determined attributes (e.g., time, product and customer), so as accelerate data access. Methods for indexing are well known to those skilled in the art and thus are not detailed here.

Data repository 114 may be configured to store the indexed data and other data such as originally obtained data, preprocessed data, etc. Data repository 114 may be a traditional relational database or a data warehouse or a NoSQL database. Preferably, data repository 114 supports some index mechanism to accelerate data access.

Data analyzing module 113 may be configured to analyze these preprocessed data by using different analysis methods with respect to product-related characteristics, at least partially based on the determined at least one attribute of the data, and may be configured to generate an event according to the analysis based on a predefined rule associated with the product-related characteristics. The event predicts possible customer demands.

With respect to different product-related characteristics, data analyzing module 113 may provide different kinds of analyzing techniques. Data analyzing module 113 can be implemented by a pluggable architecture to plug different analyzing capabilities. All the analyzing techniques can be based on attributes such as time, product, customer of data, and optionally based on other attributes associated with the data. The output of data analyzing module 113 will be the generated event, like Capacity Exceed Event, Case Increase Event, System Performance Anomaly Event, etc. Detailed operations of data analyzing module 113 will be described below in several use cases.

Optional solution module 115 may be configured to provide a corresponding solution in response to the event generated by data analyzing module 113. In some embodiments, solution module 115 may be configured to further obtain, via data obtaining module 111, data related to the analyzed product and from at least one other data source. The data obtained from at least one other data source are compared with the previously obtained data. Based on the comparison, solution module 115 may provide a corresponding solution to satisfy the user demands as indicated by the event generated by data analyzing module 113.

Optionally, data mining platform 110 may further include a data visualizing module 116 to provide an intuitive view of data and generated events. Data visualizing module 116 may be configured to visually present, in a timeline style, various information, for example, data preprocessed by data preprocessing module 112, events generated by data analyzing module 113 and/or solutions provided by solution module 115.

Data visualizing module 116 may visually present information in a preset diagram or preset format. Optionally, data visualizing module 116 may also provide custom functions so that customers may be able to customize various display modes.

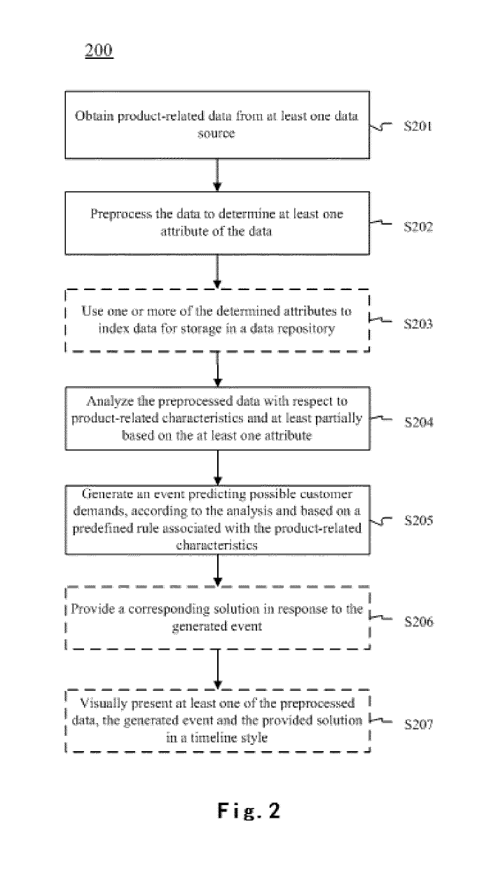

Reference is now made to FIG. 2, which description presents a workflow of a data mining platform according to an embodiment of the present disclosure. FIG. 2 illustrates a flowchart of a method for data mining according to one exemplary embodiment of the present disclosure.

In step S201 product-related data is obtained from at least one data source. The data may be retrieved based on a push by the data source (e.g., pushed periodically or in real time in response to data generation) or based on a proactive request (pull) of data obtaining module 111 (e.g., when the data mining platform demands).

In step S202, the data obtained is preprocessed so as to determine at least one attribute associated with the data. The at least one attribute may be selected from a group of attributes consisting of: related time, related product and related customer.

The preprocessing may further comprise: cleaning the data so as to determine at least one attribute associated with the data; and converting the at least one attribute associated with the data into a uniform predetermined format.

Optionally, in step S203, the data may be indexed using one or more of the attributes (e.g., time, product and customer) as determined in the preprocessing step S202, so as to be stored in a data repository and accelerate access to the data.

Subsequently in step S204, the preprocessed data is analyzed with respect to product-related characteristics, at least partially based on the at least one attribute that is determined, which is associated with the data.

Then method 200 proceeds to step S205 wherein an event is generated according to the analysis that is performed in the analyzing step S204 and based on a predefined rule associated with the product-related characteristics. For example, the event predicts possible customer demands.

Additionally, method 200 may further include step S206 where, in response to the event generated in step S205, a corresponding solution is provided to satisfy possible customer demands as indicated by the event. Further, providing a corresponding solution may include referring to data from other data source(s) to determine the corresponding solution. Specifically, data about the analyzed product and from at least one other data source may be obtained and compared with previously analyzed data, and an appropriate solution may be determined based on the comparison.

Additionally, method 200 may further include step S207 wherein at least one of the preprocessed data, the generated event and the provided solution is visually presented in a timeline style.

With reference to FIGS. 1 and 2, general description has been presented above to various function modules and a workflow of the data mining platform according to the embodiments of the present disclosure, respectively. Hereinafter, the description presented below for a data mining solution according to the embodiments of the present disclosure includes references to several use cases.

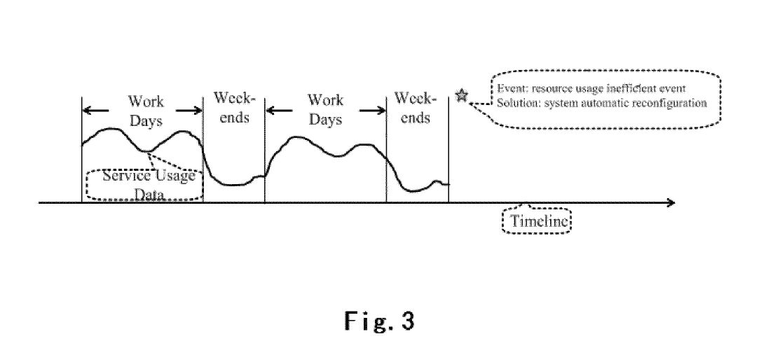

FIG. 3 illustrates a visual diagram of a use case according to one exemplary embodiment of the present disclosure. The use case in FIG. 3 relates to usage of a purchased product by a customer group (a subscriber group) that purchases the product (e.g., subscribes to a web service), wherein the web service vendor may have a plurality of online web servers so as to serve requests of the subscriber group.

Specifically, data sources may include customer data sources from the subscriber group (e.g., customer A, customer B, etc.). In this use case, data to be obtained by data obtaining module 111 may be, for example, product performance and usage data. The product performance and usage data may contain various users' usage rates of the web service as recorded with time, and the usage rate may be characterized by using the amount of HTTP requests of a terminal user.

Data analyzing module 113 (which in one embodiment can be integrated into the data obtaining module), analyzes these service usage data, e.g., performs computations like calculating a sum of all subscriber data. FIG. 3 shows analyzed service usage data in a time period (e.g., 2 weeks) that can be presented by data visualizing module 116 (which in one embodiment can be integrated into the data obtaining module) in a timeline style, wherein the horizontal axis is time, and the vertical axis is service usage rate, e.g., the amount of HTTP requests. As seen from FIG. 3, service usage or resource demand is relatively low at weekends and is relatively high on weekdays (work days). Based on the analysis of such unevenly distributed usage data, data analyzing module 113 may generate a corresponding event according to a predefined rule. The predefined rule may be, for example, that a difference between the daily HTTP requests amount on weekdays and the daily HTTP requests amount at weekends exceeds a predefined threshold, and the corresponding event generated may be a resource usage inefficient event.

In response to the generation of the resource usage inefficient event, solution module 115 (which in one embodiment can be integrated into the data obtaining module) may provide a corresponding solution. For example, in the use case shown in FIG. 3, such a solution may be provided that system reconfiguration is automatically conducted based on such a kind of time window as weekdays and weekends. More specifically, the solution provided may be that the web service provider shuts down some web servers during the weekends to save energy. FIG. 3 also shows the event generated and the provided solution.

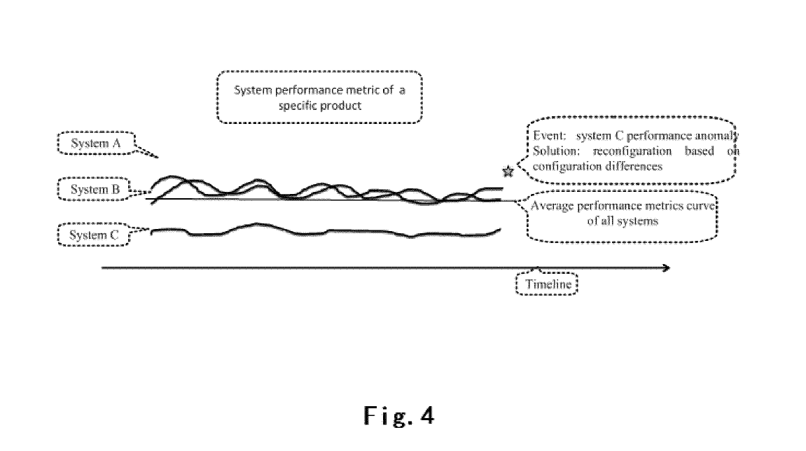

FIG. 4 shows a visual diagram of another use case according to one exemplary embodiment of the present disclosure. The use case in FIG. 4 relates to usage of purchased products (e.g., identified as system A, system B and system C) by several customers (e.g., customer A, customer B and customer C) who have purchased a certain product type (e.g., a specific storage system like VNX 7500).

Specifically, data sources may include customer data sources from these specific customers A, B and C. In this use case, data to be obtained by data obtaining module 111 may be, for example, product performance and usage data. The product performance and usage data may contain a system usage performance metric such as an average response time of the storage system, recorded with time, of respective storage systems (system A, system B and system C) by various customers (customer A, customer B and customer C).

Data analyzing module 113 (which in one embodiment can be integrated into the data obtaining module) analyzes these product performance and usage data, for example, compares system usage performance metric data of these three customers so as to find any anomaly in the data. In one embodiment, data analyzing module 113 may be implemented as a memory array response time analysis plugin.

The analysis plugin may make analysis through the following processing. The analysis plugin may include a data parser, which can read response time data of each system (e.g., system A, system B and system C) of a particular type of product (e.g., VNX 7500 storage system). A data calculating module (which in one embodiment can be integrated into the data obtaining module) in the analysis plugin may calculate individual average performance with respect to each system and calculate overall average performance with respect to all the three systems. The overall average performance may also be customer-based. For example, one customer may have multiple systems, so overall average performance may be calculated with respect to the multiple systems owned by the customer. Some algorithms like linear regression analysis may be used to calculate average performance data.

FIG. 4 illustrates analyzed product performance and usage data in a certain time period that are presented by data visualizing module 116 (which in one embodiment can be integrated into the data obtaining module) in a timeline style, wherein the horizontal axis is time and the vertical axis is calculated system average performance metric. FIG. 4 shows curves that respective average performance metrics of the three systems (system A, system B and system C) vary with time, and FIG. 4 further shows an average performance metric curve of all the systems as calculated based on an algorithm like linear regression. As seen from FIG. 4, average performance metric curves of system A and system B are closer to the average performance metric curve of all the systems, while the average performance metric curve of system C deviates far away from the average performance metric curve of all the systems.

A data associating module (which in one embodiment can be integrated into the data obtaining module) in the analysis plugin may compare the average performance metric data of each system with the overall average performance data of all the systems. Based on a predefined rule, the data associating module may ascertain a system with an abnormal performance. For example, if an average performance metric of a system is lower than the overall average performance metric by a predefined threshold, e.g., 80%, then a performance anomaly in the system may be determined and further a corresponding event may be generated, e.g., a system performance anomaly event. FIG. 4 shows the generated event, namely a system C performance anomaly.

In response to the generation of the system performance anomaly event, solution module 115 may provide a corresponding solution. For example, in the use case shown in FIG. 4, solution module 115 may view all system configurations and identify, based on a predefined rule, significant differences between system configurations of the abnormal system and other normal system. Subsequently, system configuration differences may be notified to the customer. Alternatively, a command may be automatically provided so as to apply to the abnormal system a new configuration scheme that is determined based on the identified system configuration differences.

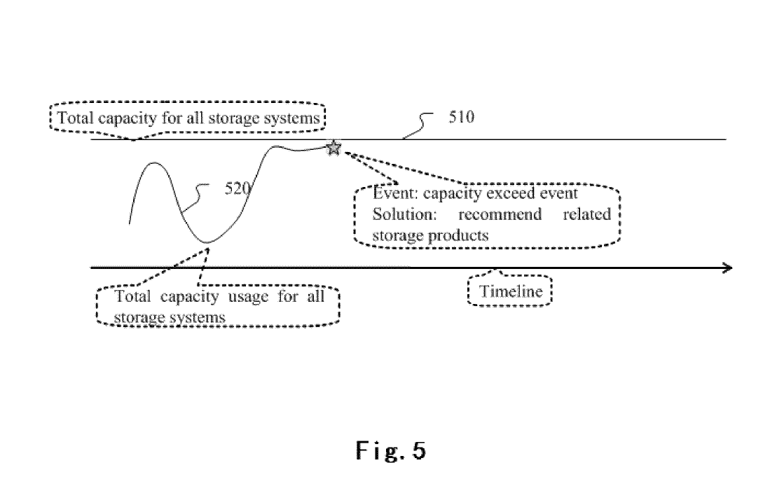

FIG. 5 illustrates a visual diagram of a further use case according to one exemplary embodiment of the present disclosure. The use case in FIG. 5 relates to usage of a purchased product by a specific customer A, who purchases the product (e.g., a specific storage system like VNX 7500).

Specifically, data sources may include a customer data source from the specific customer A. In this use case, data to be obtained by data obtaining module 111 may be, for example, sales data and product performance and usage data. The sales data may include sales information of all storage systems purchased by customer A. The product performance and usage data may contain usage such as capacity usage, recorded with time, of these purchased storage systems by customer A.

Data analyzing module 113 (which in one embodiment can be integrated into the data obtaining module) analyzes these data, for example, may calculate the total capacity of all storage systems purchased by customer A based on the sales data. The product models, detail configurations and other related data in the sales data will be referred to in the calculation process. A straight line 510 at the top of FIG. 5 represents the total capacity being calculated, wherein the horizontal axis is a time axis whose start time could be shipment time or deployment time of the storage system, and the vertical axis is storage capacity.

Next, data analyzing module 113 may analyze usage capacity of these storage systems based on the product performance and usage data. All the individual storage system usage data will be aggregated for analysis. Curve 520 in the middle of FIG. 5 shows the total capacity used for all storage systems. As seen from FIG. 5, the storage usage capacity varies with time.

Subsequently, data analyzing module 113 may predict future capacity usage based on the fitting of curve 520. The capacity usage curve may be linear or nonlinear, thus a linear fitting or curve fitting algorithm could be applied to the capacity usage curve to predict the future capacity usage. Those skilled in the art may understand that the capacity usage varies not only against time, but alternatively some other variables or parameters could also be considered, such as the amount of customers using these storage systems. In addition, it should further be noted that curve 520 in FIG. 5 contains not only raw capacity usage data but also capacity usage data predicted based on the raw capacity usage data.

By analyzing the predicted future capacity usage data, data analyzing module 113 may generate a corresponding event based on a predefined rule. For example, will the storage capacity usage reach 90% within next 5 days based on the predicted capacity usage data, then a capacity exceed event will be generated. FIG. 5 shows the generated capacity exceed event.

In response to the generation of the capacity exceed event, solution module 115 (which in one embodiment can be integrated into the data obtaining module) may provide a corresponding solution. In the use case shown in FIG. 5, for example, solution module 115 may view the data source of the storage system vendor, for example, obtain product offering data or solution offering data from the data source of the vendor via data obtaining module 111, so as to find out the most suitable product or solution and recommend them to the customer. FIG. 5 shows the provided solution, for example, recommending related products.

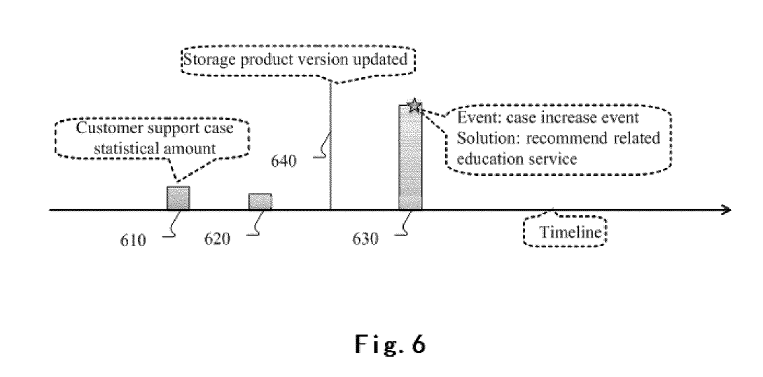

FIG. 6 illustrates a visual diagram of another use case according to one exemplary embodiment of the present disclosure. The use case in FIG. 6 relates to support case statistics and education service plan.

Specifically, data sources may include customer data sources from several customers for a specific product. In this use case, data to be obtained by data obtaining module 111 may be, for example, support case data and education service data. The support case data may include support case information that occurs after the customer purchases the product, such as the amount and symptoms of support cases, support processing procedure, etc. The education service data may include training service courses the customer has subscribed or attended.

Theoretically, the amount of support cases should gradually decrease over time. Data analyzing module 113 may include statistics on changes for the amount of customer support cases related in relation to a concrete product over a given period of time. FIG. 6 shows bar charts of customer support case statistical amounts in a timeline style. For example, bar charts 610, 620 and 630 represent the customer support case amounts in a given period (for example a week) in the time axis. In addition, considering that the customer support case amount might vary with events like product version update, data analyzing module 113 may extract a significant event related to a specific product, e.g., obtain product offering data from the data source of the product vendor via data obtaining module 111. The significant event could be software update or hardware update or a combination thereof. The event such as a storage product version update event is identified by a vertical line 640 in the time axis in FIG. 6.

Subsequently, data analyzing module 113 may analyze the data. For example, upon detecting a sudden increase (for example, indicated by bar 630) of the customer support case amount, data analyzing module 113 may look up significant events happening during the near past, so as to analyze reasons of this sudden increase. In the use case shown in FIG. 6, it is found that storage product version update event 640 might be the reason of this sudden increase.

Afterwards, data analyzing module 113 may generate a corresponding event based on some predefined rules. For example, it will generate a case increase event while detecting an abnormal case increase (for example, the support case amount exceeds a predefined threshold and deviates from the theoretical trend).

In response to the generation of the case increase event, solution module 115 may provide a corresponding solution. In the use case shown in FIG. 6, for example, solution module 115 may view the data source of a related product vendor, for example, obtains products offering data, solution offering data or education service data from the vendor data source via data obtaining module 111. In this use case, it is found from the vendor data that a lot of new training courses are provided recently with respect to the updated product version. Therefore, solution module 115 may recommend related training courses to the customer. FIG. 6 shows the solution provided, e.g., recommending related training courses.

Operations of data mining platform 110 according to the embodiments of the present disclosure have been described by using four use cases. Those skilled in the art may understand the various modules in data mining platform 110 may be hardware modules or software unit modules or a combination thereof. For example, in some embodiments, data mining platform 110 may be implemented partially or completely using software and/or firmware, e.g., implemented as a computer program product contained on a computer readable medium. Alternatively or additionally, data mining platform 110 may be implemented partially or completely based on hardware, e.g., implemented as an integrated chip (IC), application-specific integrated circuit (ASIC), system on chip (SOC), field programmable gate array (FPGA), etc. The scope of the present disclosure is not limited in this regard.

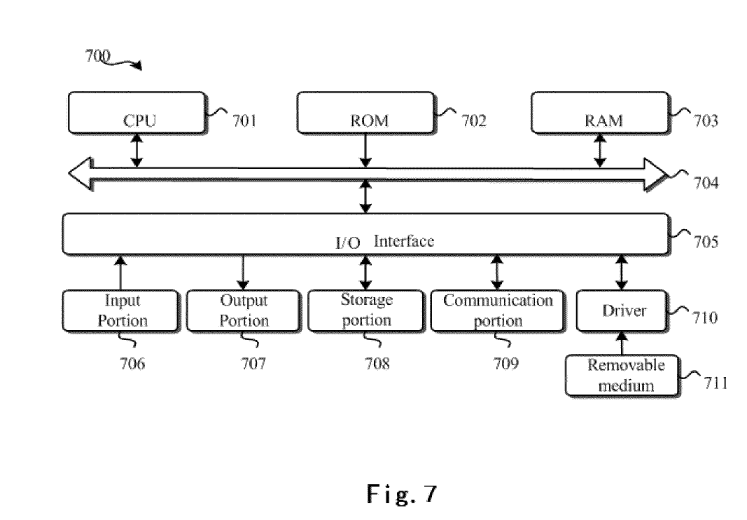

With reference to FIG. 7, this figure shows a schematic block diagram of a computer system 700 which is applicable to implement data mining platform 110 according to the embodiments of the present disclosure. As illustrated in FIG. 7, computer system 700 may include: CPU (Central Process Unit) 701, which may execute various appropriate actions and processing according to a program stored in ROM (Read Only Memory) 702 or a program loaded from a storage portion 708 to RAM (Random Access Memory) 703. Various programs and data required for operations of system 700 are further stored in RAM 703. CPU 701, ROM 702 and RAM 703 are coupled to one another via a system bus 704. An input/output (I/O) interface 705 is also coupled to bus 704.

Following components are coupled to I/O Interface 705: an input portion 706 including a keyboard, a mouse, etc.; an output portion 707 including a cathode ray tube (CRT), a liquid crystal display (LCD), a loudspeaker, etc.; a storage portion 708 including a hard drive, etc.; and a communication portion 709 including a network interface card like a LAN card, a modem, etc. Communication portion 709 performs communication processing via a network like the Internet. A driver 710 is also coupled to I/O Interface 705 according to needs. A removable medium 711 like a magnetic disk, an optical disk, a magneto-optical disk, a semiconductor memory and so on is installed on driver 710 according to needs, so that a computer program read therefrom can be installed to storage portion 708 according to needs.

Specifically, according to the embodiments of the present disclosure, the process described above with reference to FIGS. 1 to 2 may be implemented as a computer software program. For example, the embodiments of the present disclosure include a computer program product comprising a computer program tangibly contained on a machine readable medium, the computer program containing program code for executing method 200. In such an embodiment, the computer program may be downloaded and installed from a network via communication portion 709, and/or installed from removable medium 711.

Generally speaking, the various exemplary embodiments of the present disclosure may be implemented in hardware or dedicated circuit, software, logic or any combination thereof. Some aspects may be implemented in software, while others may be implemented in software or firmware executed by a controller, a microprocessor or other computing device. When the various aspects of the embodiments of the present disclosure are depicted or described as block diagrams, a flowchart or represented by some other diagrams, it is to be understood that blocks, apparatus, system, techniques or method described here may be implemented, as non-limiting examples, in hardware, software, firmware, dedicated circuit or logic, general-purpose hardware or controller or other computing device, or some combinations thereof.

Moreover, respective blocks in the flowchart may be regarded as method steps, and/or operations generated by computer program code, and/or construed as multiple coupled logical circuit elements performing related functions. For example, embodiments of the present disclosure include a computer program product, the computer program product comprising a computer program tangibly implemented on a machine readable medium, the computer program containing program code configured to implement the method described above.

Throughout the context of the present disclosure, the machine readable medium may be any tangible medium containing or storing a program used for or related to an instruction executing system, apparatus or device. The machine readable medium may be a machine readable signal medium or a machine readable storage medium. The machine readable medium may include, without limitation, an electronic, magnetic, optical, electro-magnetic, infrared or semiconductor system, apparatus or device, or any appropriate combination thereof. More detailed examples of the machine readable medium include an electric connection with one or more wires, potable computer magnetic disk, hard disk, random access memory (RAM), read only memory (ROM), erasable programmable read-only memory (EPROM or flash memory), optical storage device, magnetic storage device, or any appropriate combination thereof.

The computer program code for implementing the method of the present disclosure may be written using one or more programming languages. The computer program code may be provided to a processor of a general-purpose computer, dedicated computer or other programmable data processing device so that the program code, when being executed by a computer or other programmable data processing device, causes functions/operations specified in the flowchart and/or block diagrams to be implemented. The program code may be executed completely or partially on a computer, as a stand-alone software package, partially on a computer and partially on a remote computer or completely on a remote computer or server.

In addition, although operations are described in a specific order, it should not be construed as requiring such operations to be completed in the shown specific order or successive order, or as requiring all depicted operations to be executed for achieving desired results. In some cases, multi-task or parallel processing will be advantageous. Similarly, although the foregoing discussion includes some specific implementation details, it should not be interpreted as limiting the scope of any disclosure or claims, but interpreted as description of a specific embodiment with respect to a specific disclosure. In this specification, some features described in the context of separate embodiments may also be implemented in a single embodiment. On the contrary, each feature described in the context of a single embodiment may also be implemented separately in multiple embodiments or any appropriate sub-combination.

Various modifications and alterations to the above exemplary embodiments of the present disclosure will become apparent to those skilled in the art upon reading the foregoing description in conjunction with the accompanying drawings. Any and all modifications still fall within the non-limiting scope of the exemplary embodiments of the present disclosure. In addition, the foregoing specification and accompanying drawings have an advantage of teaching such that those skilled in the technical field of these embodiments of the present disclosure will conceive of other embodiments of the present disclosure as illustrated here.

It is to be understood that the embodiments of the present disclosure are not limited to the specific embodiments disclosed here, and modifications and other embodiments should be embraced in the scope of the appended claims. Although specific terms are used here, they are only used in a generally, descriptive sensor and not intended for the limiting purpose.

What is claimed is:

1. A method for data mining, the method comprising:
obtaining a product-related data from at least a first data source;
preprocessing the data to determine at least one attribute associated with the data;
analyzing the preprocessed data with respect to product-related characteristics and at least partially being based on the at least one attribute; and
generating an event wherein the event predicts possible customer demands.

2. The method according to claim 1, further comprising:
in response to the event, providing a corresponding solution.

3. The method according to claim 2, further comprising:
visually presenting at least one of the preprocessed data, the generated event and the solution in a timeline.

4. The method according to claim 1, further comprising:
after preprocessing the data, using the at least one attribute associated with the data to index the data for storage in a data repository.

5. The method according to claim 1, wherein the step of preprocessing further comprises:
cleansing the data to determine at least one attribute associated with the data; and
converting the at least one attribute associated with the data into a uniform predefined format.

6. The method according to claim 2, wherein the solution comprises:
obtaining a product-related data from at least a second data source, wherein the data source is different from the first data source;
comparing data from the first data source with data from the second data source; and
providing the solution based on the comparison.

7. The method according to claim 1, wherein the at least one attribute associated with the data is selected from a group comprising at least one of a related time, a related product and a related customer.

8. The method according to claim 1, wherein the data source comprises a customer data source, the data comprises a product performance and a usage data, and further comprises:
analyzing product usage rate in a timeline order according to the product performance and the usage data;
generating a resource usage inefficient event according to a predefined rule, based on a temporal distribution of the product usage rate; and
providing a time-based automatic product reconfiguration scheme based on the temporal distribution of the product usage rate.

9. The method according to claim 1, wherein the data source comprises a customer data source, the data comprises a product performance and a usage data, and further comprises:
analyzing a product usage metrics in a timeline order according to the product performance and the usage data;
generating a product performance anomaly event according to a predefined rule, based on a temporal distribution of the product usage metrics;
obtaining the product performance and the usage data related to a like product and from a second customer data source;
comparing the product performance and the usage data from the customer data source with product performance and the usage data from the second customer data source; and
providing a product performance optimization scheme based on the comparison.

10. An apparatus for data mining, the apparatus comprising:
a data obtaining module configured to
obtain product-related data from at least a first data source;
preprocess the data to determine at least one attribute associated with the data;
analyze the preprocessed data with respect to product-related characteristics and at least partially being based on the at least one attribute, and
generate an event wherein the event predicts possible customer demands.

11. The apparatus according to claim 10, further configured for:
in response to the event, provide a corresponding solution.

12. The apparatus according to claim 11, further configured to:
visually present at least one of the preprocessed data, the generated event and the solution in a timeline.

13. The apparatus according to claim 10, further configured to after preprocessing the data, use the at least one attribute associated with the data to index the data for storage in a data repository.

14. The apparatus according to claim 10, wherein the step of preprocessing is configured to
cleanse the data to determine at least one attribute associated with the data; and
converting the at least one attribute associated with the data into a uniform predefined format.

15. The apparatus according to claim 11, is configured to
obtain a product-related data from at least a second data source;
comparing data from the first data source with data from the second data source; and
providing the solution based on the comparison.

16. The apparatus according to claim 10, wherein the at least one attribute associated with the data is selected from a group comprising at least one of a related time, a related product and a related customer.

17. The apparatus according to claim 10, wherein the data source comprises a customer data source, the data comprises a product performance and a usage data, and further configured to:
analyze product usage rate in a timeline order according to the product performance and the usage data;
generate a resource usage inefficient event according to a predefined rule based on a temporal distribution of the product usage rate; and
provide a time-based automatic product reconfiguration scheme based on the temporal distribution of the product usage rate.

18. The apparatus according to claim 10, wherein the data source comprises a customer data source, the data comprises a product performance and a usage data,
analyze a product usage metrics in a timeline order according to the product performance and the usage data;
generate a produce performance anomaly event according to a predefined rule based on a temporal distribution of the product usage metrics;
obtain the product performance and the usage data related to a like product and from at least one other customer data source;
compare the product performance and usage data from the first data source with the product performance and the usage data from the at least one other customer data source; and
provide a product performance optimization scheme based on the comparison.

19. A computer program product for data mining, the computer program product being tangibly stored in a non-transient computer readable medium and including machine executable instructions, the machine executable instructions, when being executed, causing a machine to execute:
obtain product-related data from at least a first data source;
preprocess the data to determine at least one attribute associated with the data;
analyze the preprocessed data with respect to product-related characteristics and at least partially being based on the at least one attribute; and
generate an event wherein the event predicts possible customer demands.
